(19) United States
(12) Patent Application Publication
(10) Pub. No.: US 2021/0334773 A1
(43) Pub. Date: Oct. 28, 2021

(54) PAYMENT METHOD, APPARATUS AND SYSTEM AND VENDING TERMINAL

(71) Applicant: Shenzhen Lanbei Technology Co., Ltd., Shenzhen (CN)

(72) Inventors: Zhixin Chen, Shenzhen (CN); Jianjun Lin, Shenzhen (CN); Shuai Ma, Shenzhen (CN)

(21) Appl. No.: 16/478,926

(22) PCT Filed: Mar. 13, 2018
(86) PCT No.: PCT/CN2018/078857

§ 371 Date: Jul. 18, 2019

(51) Int. Cl. G06Q 20/18; G06Q 20/32

(52) U.S. Cl. CPC G06Q 20/18; G06Q 20/3276

(57) ABSTRACT

Provided in the present application is a payment method, apparatus and system and a vending terminal. In a payment method applied to a vending terminal, the vending terminal includes an item selling part and a money placing part. The payment method includes: a user money reception step, a money amount identification step, a recharge success reception step and a recharge success display step.

### TECHNICAL FIELD

The present application relates to the field of digital communications and, in particular, to a payment method, apparatus, system and vending terminal.

### BACKGROUND

With the development of technology, vending machines are more and more widely used. Vending machines have great advantages in user experience, labor costs, convenience, and the like. In some countries or regions, conventional cash transactions are used when a purchase is made with vending machines. Typically, a user needs to put cash, especially change, into a vending machine and then selects an item to be purchased. The user cannot purchase without cash. At the same time, in these countries or regions, the user cannot directly use the bank card to recharge the third party payment software due to the restrictions of basic measures of the bank. This leads to difficulties and obstacles when the user uses third-party payment for consumption.

### SUMMARY

The object of the present application is to overcome the above problem or at least partially solve or mitigate the above problem.

In an aspect of the present application, a payment method is provided and is applied to a vending terminal. The vending terminal includes an item selling part and a money placing part, and the payment method includes the steps described below.

In a user money reception step, money placed by a user into the money placing part is received.

In a money amount identification step, the money is identified and the amount of the money is displayed.

In a recharge success reception step, after a server receives identity information corresponding to information of an account to be recharged and the amount of the money, and recharges the account according to the amount, recharge success information sent by the server is received.

In a recharge success display step, the recharge success information is displayed to the user, so that the user pays for an item through the account when the user purchases the item in the item selling part by using a mobile terminal. Through the method, when the user uses the vending terminal, the user does not need to use change every time for making purchase, but may recharge the money into the software used in cooperation with the vending terminal, so that the corresponding amount can be deducted from the account balance every time the user makes purchase. The method is convenient and quick, and can improve the purchasing efficiency and the user experience.

Optionally, the method further includes: an identity information reception step in which the identity information inputted by the user to the vending terminal and corresponding to the information of the account to be recharged is received; and a recharge information sending step in which the identity information and the amount of the money are sent to the server.

Through the method, the user can input the identity information into the vending terminal, so that the vending terminal can acquire the information of the recharge account, thereby storing the money put by the user into the vending terminal into the corresponding account.

Optionally, after the identity information reception step, the method further includes: a confirmation information reception step in which recharge confirmation information from the user is received.

Optionally, after the money amount identification step, the method further includes: a quick response (QR) code display step in which the QR code is generated and displayed in response to identification of the money.

In the method, the identity information of the user can be transmitted to the server quickly and accurately by adopting the method of scanning the QR code, and the loss caused by the user input error can be prevented.

Optionally, the identity information includes at least one of: a mobile terminal number, a member number, an identity document number, or account information.

Optionally, the money includes at least one of paper money or a coin.

After the user inputs money and transmits the identity information by inputting the identity information or scanning the QR code, the method further includes the information confirmation step, thereby facilitating the customer to check the information, preventing the wrong operation and improving the accuracy.

In another aspect of the present application, a payment method is further provided. The payment method is applied to a server, and includes the steps described below.

In an information reception step, after a vending terminal receives money inputted by a user into a money placing part of the vending terminal, identifies the money, displays the amount of the money and receives identity information corresponding to information of an account to be recharged and inputted by the user, the identity information and the amount are received.

In a recharge step, the account to be recharged is recharged according to the amount.

In a recharge success information sending step, the recharge success information is sent to the vending terminal, so that the user makes payment by using a mobile terminal associated with the account when the user purchases an item in an item selling part of the vending terminal.

In the method, the server is used to record the user's operation behavior, such as recharging and payment, so that network information interaction can be implemented, and the user can use the amount in the account when the user makes purchasing payment at different vending terminals.

In another aspect of the present application, a payment method is further provided and is applied to a mobile terminal. The method includes: based on a payment method applied to a vending terminal, after the server recharges the account of the mobile terminal corresponding to the identity information according to the amount, the updated amount is displayed in response to an inquiry operation performed by the user on the balance of the account.

By using the method, the user can inquire the balance of the account in the mobile terminal in real time, thereby facilitating checking the information, and also facilitating the user to determine whether the payment can be made, whether the account needs to be recharged, and the like before the user makes a purchase with the vending terminal.

In another aspect of the present application, a payment method is further provided. The payment method is applied to a mobile terminal, and includes the steps described below.

In a QR code scanning step, after a vending terminal receives money placed by a user into a money placing part in the vending terminal, identifies the money, displays the amount of the money, and generates and displays a QR code in response to identification of the money, a camera of the mobile terminal is started to scan the QR code.

In a QR code parsing step, content of the QR code is identified and parsed, where the content includes the amount of the money.

In an information sending step, identity information corresponding to an account to be recharged and the amount of the money are sent to a server.

In a balance inquiry step, after the server recharges the account of the mobile terminal corresponding to the identity information according to the amount, an updated amount is displayed in response to an inquiry operation performed by the user on a balance of the account.

Through the method, the user can automatically complete transmission of the identity information by using the mobile terminal, thereby achieving the identity identification, so that the process of the information transmission is simpler and quicker, and the accuracy rate is greatly improved.

In another aspect of the present application, a payment apparatus is further provided and is applied to a vending terminal. The vending terminal includes an item selling part and a money placing part. The payment apparatus includes a user money reception module, a money amount identification module, a recharge success reception module, and a recharge success display module.

The user money reception module is configured to receive money placed by a user into the money placing part.

The money amount identification module is configured to identify the money and display an amount of the money.

The recharge success reception module is configured to: after a server receives identity information corresponding to information of an account to be recharged and the amount of the money, and recharges the account according to the amount, receive recharge success information sent by the server.

The recharge success display module is configured to display the recharge success information to the user, so that the user pays for an item through the account when the user purchases the item in the item selling part by using a mobile terminal.

The apparatus makes it unnecessary to use cash every time when the user selects and purchases an item by using a vending terminal. The user deposits money into a personal account in advance, which is beneficial to saving user time, improving payment speed and improving user experience.

Optionally, an identity information reception module is configured to receive the identity information inputted by the user to the vending terminal and corresponding to the information of the account to be recharged.

Optionally, the identity information reception module is further connected to a confirmation information reception module configured to receive recharge confirmation information from the user.

Optionally, the money amount identification module is further connected to a QR code display module configured to generate and display the QR code in response to identification of the money.

Optionally, the identity information includes at least one of: a mobile terminal number, a member number, an identity document number, or account information.

Optionally, the money includes at least one of paper money or a coin.

In another aspect of the present application, a payment apparatus is further provided, is applied to a server, and includes an information reception module, a recharge module and a recharge success information sending module.

The information reception module is configured to: after a vending terminal receives money inputted by a user into a money placing part of the vending terminal, identifies the money, displays the amount of the money, and receives identity information corresponding to information of an account to be recharged and transmitted by the user, receive the identity information and the amount.

The recharge module is configured to recharge the account to be recharged according to the amount.

The recharge success information sending module is configured to send the recharge success information to the vending terminal, so that the user makes payment by using a mobile terminal associated with the account when the user purchases an item in an item selling part of the vending terminal.

In another aspect of the present application, a payment apparatus is further provided. The payment apparatus is applied to a mobile terminal, and includes a balance inquiry module. The balance inquiry module is configured to: based on a payment apparatus applied to a vending terminal, after the server recharges the account of the mobile terminal corresponding to the identity information according to the amount, display the updated amount in response to an inquiry operation performed by the user on the balance of the account.

In another aspect of the present application, a payment apparatus is further provided. The payment apparatus is applied to a mobile terminal, and includes a QR code scanning module, a QR code parsing module, an information sending module, and a balance inquiry module.

The QR code scanning module is configured to: after a vending terminal receives money placed by a user into a money placing part in the vending terminal, identifies the money, displays an amount of the money, and generates and displays a QR code in response to identification of the money, start a camera of the mobile terminal to scan the QR code.

The QR code parsing module is configured to identify and parse content of the QR code. The content includes the amount of the money.

The information sending module is configured to send identity information corresponding to an account to be recharged and the amount of the money to a server.

The balance inquiry module is configured to: after the server recharges the account of the mobile terminal corresponding to the identity information according to the amount, display an updated amount in response to an inquiry operation performed by the user on a balance of the account.

In another aspect of the present application, a vending terminal is further provided, and includes a cabinet, an item selling part, a money placing part, an industrial control mechanism, and an execution mechanism, where the item selling part, the money placing part, the industrial control mechanism, and the execution mechanism are accommodated in the cabinet.

The item selling part is configured to store an item for selection by a user.

The money placing part is configured to receive money placed by the user.

The industrial control mechanism is configured to identify the money and display an amount of the money; receive identity information sent by the user and corresponding to information of an account to be recharged, send the identity information to a server, and/or generate and display a QR code in response to identification of the money; and after the server receives the identity information corresponding to the information of the account to be recharged and the amount of the money, and recharges the account to be recharged according to the amount, receive and display recharge success information.

The execution mechanism is configured to move an item selected and purchased by the user so that the user takes the item away from outside of the vending terminal.

By using the system, the user can easily use the vending terminal to make a purchase, and by installing the first application at the vending terminal and the second application at the mobile terminal, the user can make a purchase and recharge money through the vending terminal, and inquire balance through the mobile terminal. The apparatus may be a specially designed apparatus, or may be modified based on an existing vending terminal. The system is stable and safe, is better to achieve human-machine interaction, and is greatly convenient for the customer.

In another aspect of the present application, a payment system is further provided, and includes a mobile terminal, a server, and at least one vending terminal. The mobile terminal is connected to the vending terminal and the server separately via a wireless network. The vending terminal and the server are connected to each other via a wired network or a wireless network.

The vending terminal is configured to receive and identify money placed by a user, identify the money and display an amount of the money; and receive identity information inputted by the user to the vending terminal and corresponding to information of an account to be recharged, and then send the identity information and the amount to the server, and/or generate and display a QR code in response to identification of the money.

The server is configured to receive the identity information corresponding to the information of the account to be recharged and the amount of the money, and recharge the account to be recharged according to the amount.

The mobile terminal is configured to pay for an item through the account after the user selects the item in an item selling part of the vending terminal.

In another aspect of the present application, a computer device is further provided. The computer device includes a memory, a processor, and a computer program stored in the memory and capable of being run by the processor. The processor implements one of the methods described above when the processor executes the computer program.

In another aspect of the present application, a computer-readable storage medium is further provided. The computer-readable storage medium is preferably a non-volatile readable storage medium, and stores a computer program that implements one of the methods described above when the computer program is executed by a processor.

In another aspect of the present application, a computer program product is further provided. The computer program product includes computer readable codes that cause a computer device to execute one of the methods described above when the computer readable codes are executed by the computer device. The specific embodiments of the present application will be described below in detail in conjunction with the drawings, and then those skilled in the art will become clearer about the above and other objects, advantages and features of the present application.

### BRIEF DESCRIPTION OF DRAWINGS

FIG. 1 is a flowchart of a payment method applied to a vending terminal according to an embodiment of the present application;

FIG. 2 is a flowchart of a payment method applied to a vending terminal according to another embodiment of the present application;

FIG. 3 is a flowchart of a payment method applied to a vending terminal according to another embodiment of the present application;

FIG. 4 is a flowchart of a payment method applied to a mobile terminal according to an embodiment of the present application;

FIG. 5 is a flowchart of a payment apparatus applied to a vending terminal according to an embodiment of the present application;

FIG. 6 is a block diagram of a payment apparatus applied to a vending terminal according to another embodiment of the present application;

FIG. 7 is a block diagram of a payment apparatus applied to a mobile terminal according to an embodiment of the present application;

FIG. 8 is a block diagram of a payment method according to an embodiment of the present application;

FIG. 9 is a block diagram of a payment system according to an embodiment of the present application; and

FIG. 10 is a block diagram of a payment system according to another embodiment of the present application.

### DETAILED DESCRIPTION

The specific embodiments of the present application will be described below in detail in conjunction with the drawings, and those skilled in the art will become clearer about the above and other objects, advantages and features of the present application.

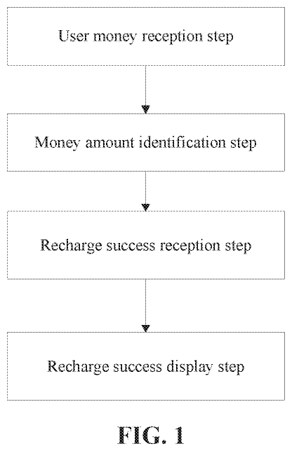

In an aspect of the present application, a mobile recharge method is provided. FIG. 1 is a flowchart of a payment method applied to a vending terminal according to an embodiment of the present application. In the method, the vending terminal includes an item selling part and a money placing part. The payment method includes the steps described below.

In a user money reception step, money placed by a user into the money placing part is received.

In a money amount identification step, the money is identified and the amount of the money is displayed.

In a recharge success reception step, after a server receives identity information corresponding to information of an account to be recharged and the amount of the money, and recharges the account to be recharged according to the amount, recharge success information sent by the server is received.

In a recharge success display step, the recharge success information is displayed to the user, so that the user pays for an item through the account when the user purchases the item in the item selling part by using a mobile terminal. The payment method may be implemented by a first application (APP), which is stored in the vending terminal. By using the method, the user may deposit cash into the first application of the vending terminal. Therefore, it is not necessary to pay by cash every time the item in the vending terminal is purchased. The money placing part in the vending terminal is configured to receive the money placed by the user. It may be understood that the user may select an operation mode. When the user selects a recharge mode, the placed money may be deposited into the account of the user. When the user selects a purchase mode, the placed money may be used to purchase the item stored in the vending terminal.

Money may include paper money, a coin, or a combination thereof. The vending terminal is configured to identify the type, the completion and the denomination of the money. If the money does not meet the requirements, the money is pushed out through a money output part or the money placing part. If the money meets the requirements, the amount of the money is calculated and displayed. If the user places two or more banknotes or two or more currencies, the denominations of the money are added, and the total amount is displayed.

After the amount of money is identified, the vending terminal prompts the user to input identity information that is used to indicate the account in which the money is to be deposited. The identity information is in one-to-one correspondence with the information of the account to be recharged. The identity information may be one of: a mobile terminal number, a member number, an identity document number, or a combination thereof.

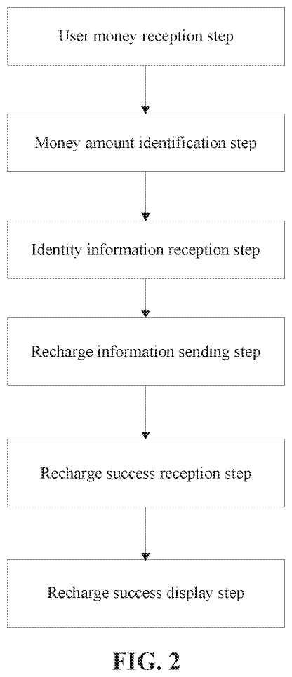

The user may transmit identity information in different manners. FIG. 2 is a flowchart of a payment method applied to a vending terminal according to another embodiment of the present application. In an optional embodiment, after the money amount identification step, the payment method further includes: an identity information reception step in which the identity information inputted by the user to the vending terminal and corresponding to the information of the account to be recharged is received; and a recharge information sending step in which the identity information and the amount of the money are sent to the server. In the embodiment, the user inputs the identity information according to the prompt through the keypad of the vending terminal or the soft keypad displayed on the screen. The identity information may include one of: a mobile terminal number, a member number, an identity document number, account information, or a combination thereof. In another optional embodiment, the identity information may also include a verification code. That is, after the user inputs one or a combination of the mobile terminal number, the member number and the identity document number, the verification code sent by the server to the mobile terminal also needs to be inputted to complete the identity authentication, thereby increasing data security.

In an optional embodiment, the step of receiving identity information of the mobile terminal transmitted by the user includes: a QR code display step in which the QR code is generated and displayed in response to identification of the money; and an identity information reception step in which after the QR code is scanned by the user through the mobile terminal and the identity information is sent by the mobile terminal, the identity information is received. In the embodiment, after the vending terminal identifies the money, the QR code is generated and displayed. The mobile terminal stores a second application corresponding to the first application. After the mobile terminal scans the QR code, the second application is used to transmit the identity information stored in the mobile terminal to the vending terminal via the wireless network.

Optionally, after the identity information reception step, the method further includes: a confirmation information reception step in which recharge confirmation information from the user is received. The user may choose to press the recharge button for confirmation. If the vending terminal does not receive the recharge confirmation information of the user within the set time, the recharge operation may continue to be performed, or be stopped and the money is pushed out. Specific execution may be set as needed.

The vending terminal sends the identity information and the amount to the server, and receives the recharge success information sent by the server after the server recharges the account to be charged according to the amount. Optionally, the recharge success information is received and is then displayed to the user, so that the user pays for an item through the account when the user purchases the item in the item selling part by using a mobile terminal.

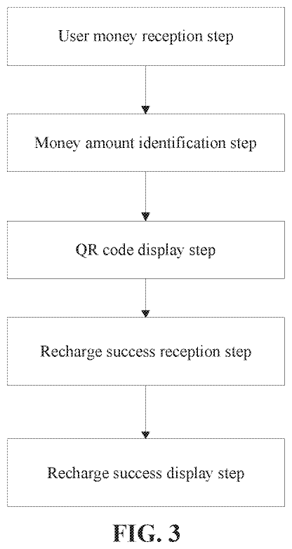

FIG. 3 is a flowchart of a payment method applied to a vending terminal according to another embodiment of the present application. In the embodiment, the user may transmit the identity information in the following manner.

After the money amount identification step, the payment method further includes: a QR code display step in which a QR code is generated and displayed in response to identification of the money. The content stored in the QR code may include an order number of the transaction and the amount of money, may optionally include time and identification information of the vending terminal, or may include other content that needs to be transmitted to the server.

The mobile terminal obtains transaction information by scanning the QR code, and transmits the identity information and the amount of money to the server. The server recharges the account of the user. It should be understood that the mobile terminal may also transmit other information required by the server.

By using the method, the user does not need to input the user identity information, and automatically transmits the information to the server by scanning the QR code, which is convenient, quick and not easy to cause errors.

It may be understood that, after completion of the recharge, the user may purchase an item in the vending terminal, or purchase an item in other similar vending terminals, or use it in other devices. That is, for a device having the first application installed, the user may interact with the device by using a mobile terminal to implement a specific function. The specific function includes, but is not limited to, recharging and/or payment.

In another aspect of the present application, a mobile recharge method is provided. The method is applied to a server, and includes the steps described below.

In an information reception step, after a vending terminal receives money inputted by a user into a money placing part of the vending terminal, identifies the money, displays the amount of the money, and receives identity information corresponding to information of an account to be recharged and inputted by the user, the identity information and the amount are received; or after a vending terminal receives money inputted by a user into a money placing part of the vending terminal, identifies the money, displays the amount of the money, and generates and displays a QR code in response to identification of the money, the identity information and the amount sent by the mobile terminal by scanning the QR code are received.

In a recharge step, the account to be recharged is recharged according to the amount.

In a recharge success information sending step, the recharge success information is sent to the vending terminal, so that the user makes payment by using a mobile terminal associated with the account when the user purchases an item in an item selling part of the vending terminal.

Information sent by the vending terminal to the server via the wired network or the wireless network includes identity information and the amount, and may also include one or more of: user position information, a vending terminal serial number, transaction time, a money type, money quantity, a verification code, and the like. After the server receives the information sent by the vending terminal, the recharge step is executed. The recharge step may include: searching for a corresponding account according to the identity information; modifying the balance of the account in the database; or determining the status of the account first, and if the account is active, modifying the balance of the account in the database. Optionally, if other information is included in the information sent by the vending terminal, the other information is stored in the database.

Through the method, the information and operations of all users may be stored and updated through the server, thereby making the transmission and acquisition of information more accurate and secure.

When the user purchases an item in an item selling part of the vending terminal and makes payment by using a mobile terminal associated with the account, the payment method further includes: receiving information and a total price of the item selected by the user and sent by the vending terminal; determining whether the balance in the user account is sufficient; and if the balance in the user account is sufficient, deducting the total price from the balance of the account and sending a balance of the account to the vending terminal and/or the mobile terminal.

In another aspect of the present application, a payment method is further provided, and is applied to a mobile terminal. In an optional embodiment, the method may include: after completion of the recharge, displaying the updated amount in response to an inquiry operation performed by the user on the balance of the account.

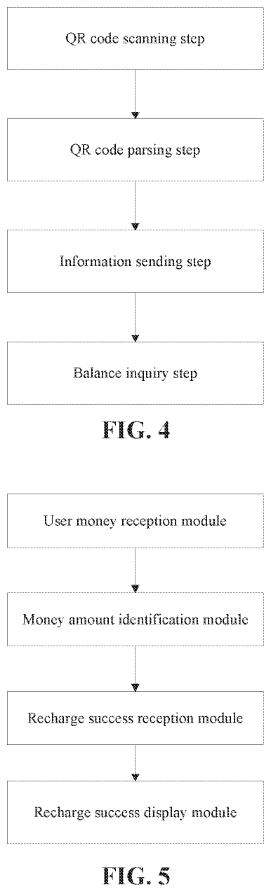

FIG. 4 is a flowchart of a payment method applied to a mobile terminal according to an embodiment of the present application. In an optional embodiment, if the user identity is confirmed by scanning the QR code, the payment method may include the steps described below.

In a QR code scanning step, after a vending terminal receives money placed by a user into a money placing part in the vending terminal, identifies the money, displays an amount of the money, and generates and displays a QR code in response to identification of the money, a camera of the mobile terminal is started to scan the QR code.

In a QR code parsing step, content of the QR code is identified and parsed, where the content includes the amount of the money.

In an information sending step, identity information corresponding to an account to be recharged and the amount of the money are sent to a server. In an identity information reception step, identity information corresponding to the account to be recharged is sent to the vending terminal.

In a balance inquiry step, after the server recharges the account of the mobile terminal corresponding to the identity information according to the amount, an updated amount is displayed in response to an inquiry operation performed by the user on a balance of the account. An updated amount is displayed in response to an inquiry operation performed by the user on a balance of the account.

The mobile terminal scans the QR code. Then the second application in the mobile terminal may obtain the account information of the user by parsing the content of the QR code and transmit the account information of the user to the vending terminal.

Through the method, the user does not need to manually input the user identity information, and the information interaction can be quickly implemented by scanning the QR code, which is convenient and quick, and is not easy to cause errors.

In another aspect of the present application, a payment apparatus is further provided. FIG. 5 is a flowchart of the payment apparatus applied to a vending terminal according to an embodiment of the present application. The payment apparatus is applied to the vending terminal. The vending terminal includes an item selling part and a money placing part. The payment apparatus includes: a user money reception module, a money amount identification module, a recharge success reception module and a recharge success display module.

The user money reception module is configured to receive money placed by a user into the money placing part.

The money amount identification module is configured to identify the money and display an amount of the money.

The recharge success reception module is configured to: after a server receives identity information corresponding to information of an account to be recharged and the amount of the money, and recharges the account according to the amount, receive recharge success information sent by the server.

The recharge success display module is configured to display the recharge success information to the user, so that the user pays for an item through the account when the user purchases the item in the item selling part by using a mobile terminal.

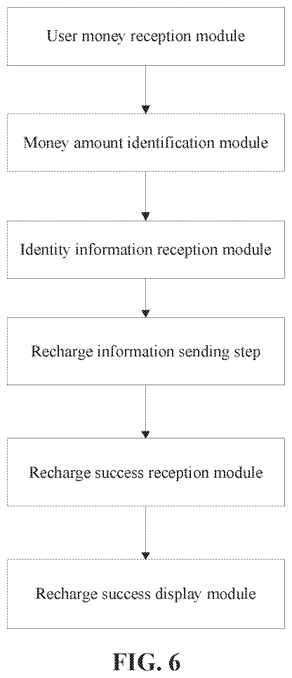

Optionally, FIG. 6 is a block diagram of a payment apparatus applied to a vending terminal according to another embodiment of the present application. The money amount identification module is further connected to: the identity information reception module configured to receive the identity information inputted by the user to the vending terminal and corresponding to the information of the account to be recharged; and the recharge information sending module configured to send the identity information and the amount of the money to the server.

Optionally, in another embodiment, the money amount identification module is further connected to: a QR code display module configured to generate and display the QR code in response to identification of the money.

Optionally, the identity information reception module is further connected to a confirmation information reception module configured to receive recharge confirmation information from the user.

The identity information may include at least one of: a mobile terminal number, a member number, an identity document number, or account information. The money includes at least one of paper money or a coin.

In another aspect of the present application, a payment apparatus is further provided, and is applied to a server. The apparatus includes: an information reception module, a recharge module and a recharge success information sending module.

The information reception module is configured to: after a vending terminal receives money inputted by a user into a money placing part of the vending terminal, identifies the money and displays the amount of the money, receive the identity information and the amount transmitted by the vending terminal or the mobile terminal.

The recharge module is configured to recharge the account to be recharged according to the amount.

The recharge success information sending module is configured to send the recharge success information to the vending terminal, so that the user makes payment by using a mobile terminal associated with the account when the user purchases an item in an item selling part of the vending terminal.

In another aspect of the present application, a payment apparatus is further provided. The payment apparatus is applied to a mobile terminal, and includes a balance inquiry module. The balance inquiry module is configured to: while or after the payment step of the vending terminal is completed, display the updated amount in response to an inquiry operation performed by the user on the balance of the account.

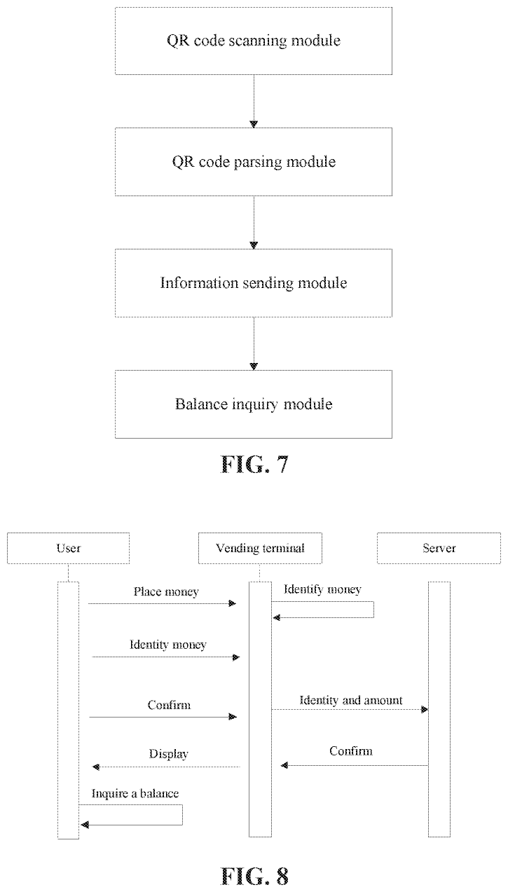

In another aspect of the present application, a payment apparatus is further provided, and is applied to a mobile terminal. FIG. 7 is a block diagram of a payment apparatus applied to a mobile terminal according to an embodiment of the present application. The apparatus includes: a QR code scanning module, a QR code parsing module, an information sending module, and a balance inquiry module.

The QR code scanning module is configured to: after a vending terminal receives money placed by a user into a money placing part in the vending terminal, identifies the money, displays an amount of the money, and generates and displays a QR code in response to identification of the money, start a camera of the mobile terminal to scan the QR code.

The QR code parsing module is configured to identify and parse content of the QR code. The content includes the amount of the money.

The information sending module is configured to send the identity information corresponding to an account to be recharged to a server or send the identity information corresponding to the account to be recharged and the amount of the money to the server.

The balance inquiry module is configured to: while or after the server recharges the account of the mobile terminal corresponding to the identity information according to the amount and the vending terminal receives recharge success information sent by the server and displays the recharge success information to the user, display the updated amount in response to an inquiry operation performed by the user on the balance of the account.

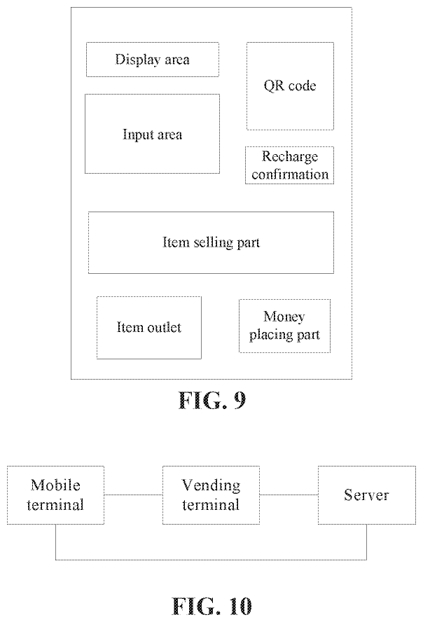

FIG. 8 is a block diagram of a payment method according to an embodiment of the present application. In the payment method provided in the present application, the user places money into the vending terminal and provides identity information. The vending terminal sends the information to the server. The server completes the recharging operation in the background and returns confirmation information to the vending machine. The mobile terminal of the user also updates data in real time, and displays the current balance in the mobile terminal when the user inquires the balance. The method can greatly save the user's purchasing time and the operation process, and improve user experience. In another aspect of the present application, a vending terminal is further provided. FIG. 9 is a block diagram of a payment system according to an embodiment of the present application. The vending terminal includes a cabinet, an item selling part, a money placing part, an industrial control mechanism (not shown), and an execution mechanism (not shown). The item selling part, the money placing part, the industrial control mechanism, and the execution mechanism are accommodated in the cabinet. The money placing part is configured to receive money placed by the user. The industrial control mechanism is configured to implement human-machine interaction, including: identify the money and display the amount of the money; receive identity information sent by the user and corresponding to information of an account to be recharged, send the identity information to a server, and/or generate and display a QR code in response to identification of the money; and after the server recharges the account to be recharged according to the amount, receive and display recharge success information. The execution mechanism is configured to move an item selected and purchased by the user, so that the user takes the item away from the vending terminal. An input area, a display area, and a QR code display area may be included on the panel of the vending terminal. The display area is used for displaying information inputted by the user in the input area. Optionally, a recharge confirmation button may also be provided on the panel. When the user clicks the button, the amount and user identification information are sent to the server. The item selling part is configured to store items for the user to select and purchase, and may have a transparent window through which the user can see the items to be sold inside the vending terminal. Optionally, the item selling part may also be an electronic display screen for displaying the name and the selling price of the item to be sold. The user may select a desired item on the screen, or select the item by typing the item information or serial number in the input area. The item outlet is configured to place the item that the user has purchased, so that the user can take the item out of the vending terminal. When the user makes a purchase with the vending terminal, the user may complete payment by scanning, through the mobile terminal, the QR code generated by the vending terminal, and take out the purchased item from the item outlet.

In another aspect of the present application, a payment system is further provided. FIG. 10 is a block diagram of a payment system according to another embodiment of the present application. The system includes a mobile terminal, a server, and at least one vending terminal. The mobile terminal is connected to the vending terminal and the server separately via a wireless network. The vending terminal and the server are connected to each other via a wired network or a wireless network. The vending terminal is configured to: receive and identify money placed by a user, receive identity information transmitted by the user and corresponding to information of an account to be recharged, send the identity information and the amount to a server, and/or generate and displays a QR code in response to identification of the money. The server is configured to receive the identity information corresponding to the information of the account to be recharged and the amount of the money, and recharge the account to be recharged according to the amount. The mobile terminal is configured to make payment through the account when the user purchases at least one item in the vending terminal.

A computer device is further provided in an embodiment of the present application, and includes a memory, a processor, and a computer program stored in the memory and capable of being run by the processor. The processor implements any one of the methods described above when the processor executes the computer program.

A computer-readable storage medium is further provided in an embodiment of the present application, is preferably a non-volatile readable storage medium, and stores a computer program that implements any one of the methods described above when the computer program is executed by a processor. A computer program product including instructions is further provided in an embodiment of the present application, and includes computer readable codes that cause a computer device to execute any one of the methods described above when the computer readable codes are executed by the computer device. The mobile device may be any electronic product, such as a mobile phone, a smartphone, a personal digital assistant (PDA), a wearable device, a palm personal computer (PPC) and a tablet computer, which is capable of performing human-machine interaction with a user through a keyboard, a mouse, a touch screen, a voice control device, a handwritten device, or the like. The network includes, but is not limited to, the Internet, a wide area network, a metropolitan area network, a local area network, a virtual private network (VPN) network, a wireless ad hoc network, and the like.

The embodiments described above may be implemented in whole or in part by software, hardware, firmware, or any combination thereof. Implementation by software may be implementation in whole or in part in the form of a computer program product. The computer program product includes one or more computer instructions. When the compute loads and executes the computer program instructions, the flows or functions described in accordance with embodiments of the present application are generated in whole or in part. The computer may be a general-purpose computer, a special-purpose computer, a computer network, or other programmable apparatuses. The computer instructions may be stored in a computer-readable storage medium, or transmitted from one computer-readable storage medium to another computer-readable storage medium. For example, the computer instructions may be transmitted from one web site, computer, server, or data center to another web site, computer, server, or data center in a wired way (e.g., through a coaxial cable, an optical fiber, and a digital subscriber line (DSL)) or in a wireless (e.g., infrared, wireless, microwave, etc.) way. The computer-readable storage medium may be any available medium that can be accessed by a computer or an integrated data storage device such as a server, a data center, or the like that includes one or more available media. The available medium may be a magnetic medium (e.g., a floppy disk, a hard disk, and a magnetic tape), an optical medium (e.g., a DVD), a semiconductor medium (e.g., a solid state disk (SSD)), or the like.

Those skilled in the art should be further aware that, the units and algorithm steps of the examples described in conjunction with the embodiments disclosed herein can be implemented in electronic hardware, computer software, or a combination thereof. In order to clearly illustrate the interchangeability of hardware and software, the composition and steps of the examples have been described generally in terms of functionality in the foregoing description. Whether these functions are performed in hardware or software depends on the specific application and design constraints of the technical solution. Those skilled in the art may use different methods to implement the described functions for each specific application, but such implementation should not be considered to be beyond the scope of the present application.

It may be understood by those skilled in the art that all or part of the steps in the methods of the above embodiments may be implemented by programs instructing the processor to perform. The programs may be stored in a computer-readable storage medium. The storage medium is a non-transitory medium, such as a random access memory, a read-only memory, a flash memory, a hard disk, a solid state disk, a magnetic tape, a floppy disk, an optical disc, and any combination thereof.

In summary, the above are only preferred specific embodiments of the present application and are not intended to limit the present application. It is easy for those skilled in the art to conceive modifications or substitutions within the technical scope of the present application. These modifications or substitutions are within the scope of the present application. Therefore, the protection scope of the present application is subject to the scope of the claims.

1. A payment method, applied to a vending terminal, wherein the vending terminal comprises an item selling part and a money placing part, and the payment method comprises:
a user money reception step comprising receiving money placed by a user into the money placing part;
a money amount identification step comprising identifying the money and displaying an amount of the money;
a recharge success reception step comprising, after a server receives identity information corresponding to information of an account to be recharged and the amount of the money, and recharges the account according to the amount, receiving recharge success information sent by the server; and
a recharge success display step comprising displaying the recharge success information to the user, so that the user pays for an item through the account when the user purchases the item in the item selling part by using a mobile terminal.

2. The method of claim 1, wherein after the money amount identification step, the method further comprises:
an identity information reception step comprising receiving the identity information inputted by the user to the vending terminal and corresponding to the information of the account to be recharged; and
a recharge information sending step comprising sending the identity information and the amount of the money to the server.

3. The method of claim 2, wherein after the recharge information sending step, the method further comprises:
a confirmation information reception step comprising receiving recharge confirmation information from the user.

4. The method of claim 1, wherein after the money amount identification step, the method further comprises:
a quick response (QR) code display step comprising generating and displaying a QR code in response to identification of the money.

5. A payment method, applied to a mobile terminal and comprising:
a quick response (QR) code scanning step comprising, after a vending terminal receives money placed by a user into a money placing part in the vending terminal, identifies the money, displays an amount of the money, and generates and displays a QR code in response to identification of the money, starting a camera of the mobile terminal to scan the QR code;
a QR code parsing step comprising identifying and parsing content of the QR code, wherein the content comprises the amount of the money;
an information sending step comprising sending identity information corresponding to an account to be recharged and the amount of the money to a server; and
a balance inquiry step comprising after the server recharges the account of the mobile terminal corresponding to the identity information according to the amount, displaying an updated amount in response to an inquiry operation performed by the user on a balance of the account.

6. A payment apparatus, applied to a vending terminal, wherein the vending terminal comprises an item selling part and a money placing part, and the payment apparatus comprises:
a processor; and
a memory for storing instructions executable by the processor,
wherein the processor is configured to implement a payment method applied to a vending terminal, wherein the vending terminal comprises an item selling part and a money placing part, and the payment method comprises:
a user money reception step comprising receiving money placed by a user into the money placing part;
a money amount identification step comprising identifying the money and displaying an amount of the money;
a recharge success reception step comprising, after a server receives identity information corresponding to information of an account to be recharged and the amount of the money, and recharges the account according to the amount, receiving recharge success information sent by the server; and
a recharge success display step comprising displaying the recharge success information to the user, so that the user pays for an item through the account when the user purchases the item in the item selling part by using a mobile terminal.

7. The apparatus of claim 6, wherein the processor is further configured to:
receive the identity information inputted by the user to the vending terminal and corresponding to the information of the account to be recharged; and
send the identity information and the amount of the money to the server.

8. The apparatus of claim 6, wherein the money amount identification module is further connected to:
a quick response (QR) code display module, which is configured to generate and display a QR code in response to identification of the money.

9. A vending terminal, comprising a cabinet, an item selling part, a money placing part, an industrial control mechanism, and an execution mechanism, wherein the item selling part, the money placing part, the industrial control mechanism, and
the execution mechanism are accommodated in the cabinet, wherein:
the item selling part is configured to store an item for selection by a user;
the money placing part is configured to receive money placed by the user;
the industrial control mechanism is configured to identify the money and display an amount of the money, receive identity information sent by the user and corresponding to information of an account to be recharged, send the identity information to a server, and/or generate and display a quick response (QR) code in response to identification of the money, and after the server receives the identity information corresponding to the information of the account to be recharged and the amount of the money, and recharges the account to be recharged according to the amount, receive and display recharge success information; and
the execution mechanism is configured to move an item selected and purchased by the user so that the user takes the item away from outside of the vending terminal.

10. (canceled)

11. The method of claim 2, wherein after the money amount identification step, the method further comprises:
a QR code display step comprising generating and displaying a QR code in response to identification of the money.

12. The method of claim 3, wherein after the money amount identification step, the method further comprises:
a QR code display step comprising generating and displaying a QR code in response to identification of the money.

13. The apparatus of claim 7, wherein the money amount identification module is further connected to:
a QR code display module, which is configured to generate and display a QR code in response to identification of the money.
